(19) United States
(12) Patent Application Publication
(10) Pub. No.: US 2018/0048930 A1
(43) Pub. Date: Feb. 15, 2018

(54) MULTIMEDIA PROCESSING SYSTEM AND CONTROL METHOD THEREOF

(71) Applicant: MStar Semiconductor, Inc., Hsinchu Hsien (TW)

(72) Inventors: Yu-Shen Chou, Hsinchu Hsien (TW); Yi-Ying Liao, Hsinchu Hsien (TW); Ko-Yin Lai, Hsinchu Hsien (TW); Tai-Lai Tung, Hsinchu Hsien (TW)

(21) Appl. No.: 15/452,930

(22) Filed: Mar. 8, 2017

(30) Foreign Application Priority Data
Aug. 15, 2016 (TW) 105125880

(51) Int. Cl. H04N 21/43; H04N 21/254; H04N 21/845; H04N 21/4627; H04N 21/44; H04N 21/61; H04N 21/25; H04N 21/4408

(52) U.S. Cl. CPC H04N 21/4307; H04N 21/25; H04N 21/2541; H04N 21/4408; H04N 21/4627; H04N 21/44004; H04N 21/6143; H04N 21/6118; H04N 21/6112; H04N 21/845

(57) ABSTRACT

A multimedia processing system for processing a plurality of transport streams of different digital video broadcasting standards includes: a configuration module, generating a control signal; a descrambler, receiving a single transport stream and the control signal to generate header information, data information and padding information; a data processing module, generating an input stream synchronization signal and transport stream packet processed information according to the output of the descrambler; a timing control module, receiving the padding information, the input transport stream synchronization signal and the control signal to generate a time-to-output signal and a packet interval signal; and an output module, receiving the time-to-output signal, the packet interval signal, the transport stream packet processed information and the control signal to generate output stream information.

This application claims the benefit of Taiwan application Serial No. 105125880, filed Aug. 15, 2016, the subject matter of which is incorporated herein by reference.

### BACKGROUND OF THE INVENTION

### Field of the Invention

The invention relates in general to a multimedia processing system and a control method thereof, and more particularly to a multimedia processing system capable of integrating transport streams of multiple digital video broadcasting standards and a control method thereof.

### Description of the Related Art

Current digital video broadcasting standards include Digital Video Broadcasting-Satellite-Generation Two (DVB-S2), Digital Video Broadcasting-Cable-Generation Two (DVB-C2), and Digital Video Broadcasting-Terrestrial-Generation Two (DVB-T2). However, corresponding hardware equipments can only perform coding transport streams of one single type of video digital broadcasting standard, and thus lack flexibilities for expansion and convenience.

Therefore, there is a need for a multimedia processing system and control method capable of integrating transport streams of multiple digital video broadcasting standards.

### SUMMARY OF THE INVENTION

The invention is directed to a multimedia processing system and control method capable of integrating transport streams of multiple digital video broadcasting standards.

The present invention discloses a multimedia processing system for processing a plurality of transport streams of multiple digital video broadcasting standards. The multimedia processing system includes: a configuration module, generating a control signal corresponding to the plurality of transport streams to configure subsequent operations; a descrambler, coupled to the configuration module, receiving one of the plurality of transport streams and the control signal to generate header information, data information and padding information; a data processing module, coupled to the descrambler and the configuration module, receiving the control signal, the header information, the data information and the control signal to generate an input stream synchronization signal and transport stream packet processed information; a timing control module, coupled to the data processing module and the configuration module, receiving the padding information, the input stream synchronization signal and the control signal to generate a time-to-output signal and a packet interval signal; and an output module, coupled to the data processing module, the timing control module and the configuration module, receiving the time-to-output signal, the packet interval signal, the transport stream packet processing signal and the control signal to generate output stream information. The multiple digital video broadcasting standards include Digital Video Broadcasting-Satellite-Generation Two (DVB-S2), Digital Video Broadcasting-Cable-Generation Two (DVB-C2), and Digital Video Broadcasting-Terrestrial-Generation Two (DVB-T2).

The present invention further discloses a control method for processing a plurality of transport streams of multiple digital video broadcasting standards applicable to a multimedia processing system. The multimedia processing system includes a configuration module, a descrambler, a data processing module, a timing control module and an output module. The control method includes: generating a control signal corresponding to the plurality of transport streams by the configuration module; receiving one of the plurality of transport streams and the control signal to generate header information, data information and padding information by the descrambler; generating an input stream synchronization signal and transport stream packet processed information according to the header information, the data information and the control signal by the data processing module; generating a time-to-output signal and a packet interval signal according to the padding information, the input stream synchronization signal and the control signal by the timing control module; and generating output stream information according to the time-to-output signal, the packet interval signal and the transport stream packet processed information by the output signal. The multiple digital video broadcasting standards include DVB-S2, DVB-C2 and DVB-T2.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a multimedia processing system according to an embodiment of the present invention;

FIG. 2 is a detailed block diagram of a data processing module according to an embodiment of the present invention;

FIG. 3 is a detailed block diagram of a timing control module according to an embodiment of the present invention;

FIG. 4 is another detailed block diagram of a timing control module according to an embodiment of the present invention; and

FIG. 5 is a flowchart of a control process according to an embodiment of the present invention.

### DETAILED DESCRIPTION OF THE INVENTION

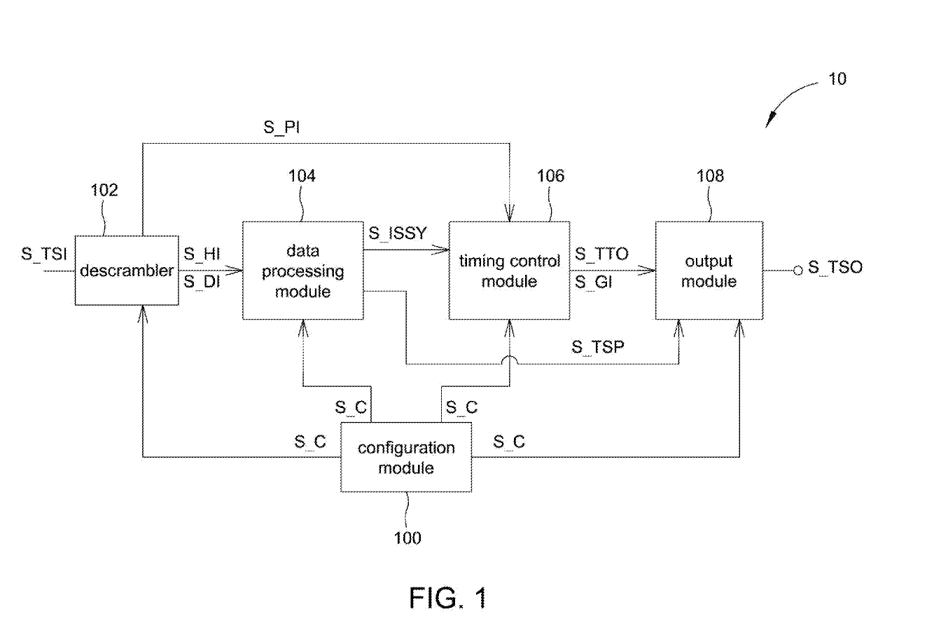

FIG. 1 shows a block diagram of a multimedia processing system 10 according to an embodiment of the present invention. As shown in FIG. 1, the multimedia processing system 10 of the embodiment includes a configuration module 100, a descrambler 102, a data processing module 104, a timing control module 106 and an output module 108. Preferably, the multimedia processing system 10 of the embodiment is used to process a plurality of transport streams of multiple digital video broadcasting standards, including Digital Video Broadcasting-Satellite-Generation Two (DVB-S2), Digital Video Broadcasting-Cable-Generation Two (DVB-C2), and Digital Video Broadcasting-Terrestrial-Generation Two (DVB-T2). In the above situation, after the multimedia processing system 10 receives a plurality of transport streams of one of the DVB-S2, DVB-C2 and DVB-T2 standards, it may determine the type of the video broadcasting standard and activate associated operations to output complete video broadcasting signals for a viewer to view. Associated details are given below.

Again referring to FIG. 1, after the multimedia processing system 10 receives a plurality of transport streams of one of the DVB-S2, DVB-C2 and DVB-T2 standards, the configuration module 100 of the embodiment may generate a control signal S_C corresponding to the transport streams to configure subsequent operations. For example, in this embodiment, the control signal S_C in a value “0” may be set to represent a plurality of transport streams of the DVB-S2 standard, the control signal S_C in a value “1” may be set to represent a plurality of transport streams of the DVB-C2 standard, and the control signal S_C in a value “2” may be set to represent a plurality of transport streams of the DVB-T2 standard. However, the above examples are not to be construed as limitations to the scope of the present invention. Further, once the multimedia processing system 10 begins to receive the transport streams, the timing control module 106 of the embodiment activates a free-run counter to obtain a reference time point, so as to later generate a time-to-output signal S_TTO.

The descrambler 102, coupled to the configuration module 100, receives the plurality of transport streams and the control signal S_C to generate header information S_HI, data information S_DI and padding information S_PI corresponding to each of the transport streams S_TSI. Preferably, in the embodiment, the descrambler 102 may receive a type determining signal to determine whether the current transport streams is common physical layer pipe (PLP) data or non-common PLP data, with “0” representing common PLP data and “1” representing non-PLP data. Meanwhile, the descrambler 102 performs descrambling on a baseband frame signal in each of the transport streams S_TSI; that is, the descrambling is performed on a predetermined number of bits selected from most significant bits(MSBs) to generate the header information S_HI, the data information S_DI and the padding information S_Pl. The predetermined number of bits is determined according to a coding rate of the descrambling, and associated details are generally known to one person skilled in the art and shall be omitted.

In the embodiment, the data processing module 104, coupled to the descrambler 102 and the configuration module 100, receives the header information S_HI, the data information S_DI and the control information S_C to generate an input stream synchronization signal SISSY and transport stream packet processed information S_TSP (i.e., associated data parsed from the header information). Further, the timing control module 106, coupled to the data processing module 104 and the configuration module 100, receives the padding information S_PI, the input stream synchronization signal S_ISSY and the control signal S_C to generate a time-to-output signal S_TTO and a packet interval space S_GI. The output module 108, coupled to the data processing module 104, the timing control module 106 and the configuration module 100, receives the time-to-output signal S_TTO, the packet interval signal S_GI, the transport stream packet processing data S_TSP and the control signal S_C to generate output stream information S_TSO.

In other words, in the embodiment, the configuration module 100 controls the descrambler 102, the data processing module 104, the timing control module 106 and the output module 108 to perform associated operations according the coding of the DVB-S2, DVB-C2 or DVB-T2 standard to be performed. The DVB-S2, DVB-C2 or DVB-T2 standard to be performed may be inputted by a manufacturer or a user. In another embodiment, the DVB-S2, DVB-C2 or DVB-T2 standard to be performed may be determined by the configuration module 100 according to the transport streams S_TSI received. Thus, the system architecture of the embodiment may be universally applicable to the coding of the DVB-S2, DVB-C2 and DVB-T2 standards, hence effectively enhancing expansion flexibilities and convenience of associated hardware equipments.

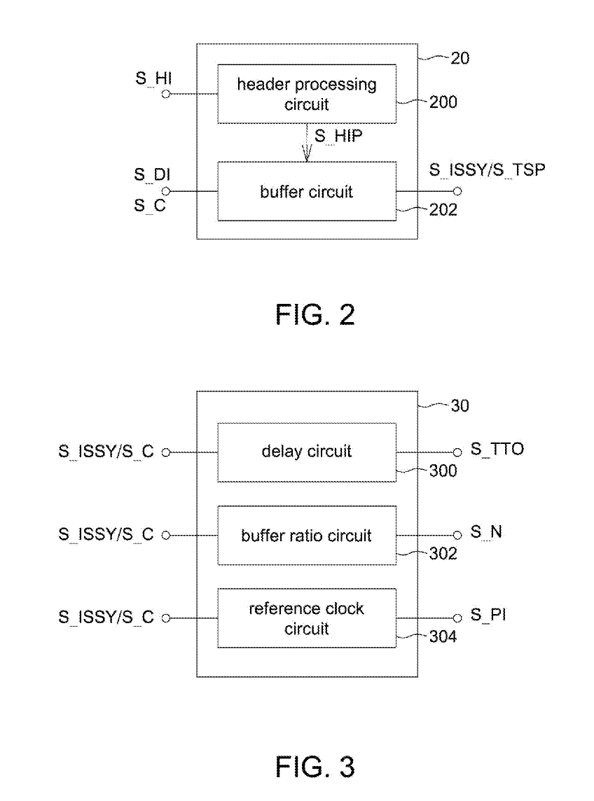

FIG. 2 shows a detailed block diagram of a data processing module 20 according to an embodiment of the present invention. As shown in FIG. 2, in the embodiment, the data processing module 20 includes a header processing circuit 200 and a buffer processing circuit 202. In the embodiment, the header processing circuit 200 receives the header information S_HI to generate header processed information S_HIP, and transmits the header processed information S_HIP to the buffer processing circuit 202. Preferably, the header processing circuit 200 in the embodiment adopts a cyclic redundancy check (CRC) error detection to determine whether the header information S_HI operates in a normal mode or in a high efficiency mode. For example, the embodiment may use a signal S_NM to represent the normal mode and a signal S_HEM to represent a high efficiency mode. When the signal S_NM is “0” and the signal S_HEM is “1”, the header processing circuit 200 may determine to activate operations associated with the DVB-C2 or DVB-T2 standard. When the signal S_NM is “0” and the signal S_HEM is absent, the header processing circuit 200 may determine to activate operations associated with the DVB-S2 standard. It should be noted that the above examples are not to be construed as limitations to the scope of the present invention. Further, the header processing circuit 200 may perform parsing on different transport streams. For example, the header processing circuit 200 may parse associated data in an MATYPE field, a UPL field, a DFL field, a SYNC field (or an ISSY field), a SYNC field and a CRC-8 MODE field in the header information S_HI to generate the header processed information S_HIP (i.e., associated information from having parsed the above fields) to the buffer processing circuit 202.

The buffer processing circuit 202 receives the header processed information S_HIP, the control signal S_C and the data information S_DI to generate the input stream synchronization signal S_ISSY and the transport stream packet processed information S_TSP. Preferably, the buffer processing circuit 202 of the embodiment may correspondingly buffer the common PLP data or non-common PLP data, i.e., receiving the header processed information S_HIP from the header processing circuit 200. The header processed information S_HIP includes a 188-byte transport stream packet to be processed, 3-byte input stream synchronization (ISSY) information and a 1-byte delete null packet (DNP). Further, the buffer processing circuit 202 may edit or rewrite associated configuration values to the header processed information S_HIP. For example, when the header processing circuit 200 determines that the high efficiency mode is to be performed, the buffer processing circuit 202 re-inserts 3-byte input stream synchronization information to the transport stream packet to be processed; when the processing circuit 200 determines that the input stream synchronization information is not to be used, the buffer processing unit 202 writes a predetermined value 0xFFFFFF to an associated field, and outputs the corresponding transport stream packet processed information S_TSP to the output module 108 and the input stream synchronization signal S_ISSY to the timing control module 106 after the buffer processing unit 202 completes its operation. It should be noted that, the above setting values in the embodiment are for illustration purposes, and are not limitations to the scope of the present invention.

FIG. 3 shows a detailed block diagram of a timing control module 30 according to an embodiment of the present invention. As shown in FIG. 3, the timing control module 30 of the embodiment includes a delay circuit 300, a buffer ratio circuit 302 and a reference clock circuit 304. More specifically, the delay circuit 300 receives the input stream synchronization signal S_ISSY and the control signal S_C to generate the time-to-output signal S_TTO. Preferably, the delay circuit 300 of the embodiment parses the input stream synchronization signal S_ISSY to obtain the time-to-output signal S_TTO or a buffer state (BUFSTAT) signal. The time-to-output signal S_TTO is in a unit of time, and defines the time needed between completely receiving a baseband frame signal and outputting the output stream information S_TSO. The buffer state signal may represent that a first-in-first-output (FIFO) buffer has received the input stream synchronization signal S_ISSY, and defines a difference between an input bit and an output bit.

The buffer ratio circuit 302 receives the input stream synchronization signal S_ISSY and the control signal S_C to generate a buffer data number signal S_N. Preferably, the buffer ratio circuit 302 of the embodiment parses the input stream synchronization signal S_ISSY to generate the buffer data number signal S_N such that a buffer space needed for a dejitter buffer is generated and the buffer spaces needed for the common PLP data and the non-common PLP data are distinguished.

Further, the reference clock circuit 304 receives the input stream synchronization signal S_ISSY and the control signal S_C to generate the packet interval signal S_GI. Preferably, the reference clock circuit 304 of the embodiment may refer to two consecutive input stream clock reference (ISCR) signals to calculate the packet interval signal S_GI to further determine the output rate of the output stream information S_TSO. Details of the above calculation are generally known to one person skilled in the art, and shall be omitted herein.

Again referring to FIG. 1 and FIG. 3, with reference to the time-to-output signal S_TTO, the packet interval signal S_GI, the transport stream packet processed information S_TSP and the control signal S_C, the output module 108 generates the output stream information S_TSO. Preferably, when a reference time point accumulated by the free-run counter is greater than or equal to a delay period corresponding to the time-to-output signal S_TTO and the PLP, or when an accumulated value of a buffer counter is greater than or equal to a value corresponding to the buffer state signal, the output module 108 may correspondingly output the output stream information S_TSO.

The output module 108 of the embodiment further performs a null packet insertion to correspondingly output the output stream information S_TSO. Preferably, a DNP field of the transport stream may be used to represent the number of null packets that need to be deleted from the transport stream. In the embodiment, the header processing circuit 200 first obtains associated information of the number of deleted null packets, and the associated information is forward from the buffer processing circuit 202 to the output module 108. The null packet insertion is then performed by the output module 108 to generate the output stream information S_TSO.

The output module 108 of the embodiment further performs calibration to determine how to output the common PLP data and the non-common PLP data (i.e., the foregoing output stream information S_TSO). For example, if the control signal S_C is “0”, the output module 108 refers to a comparison result between a partial reference counter and an input stream clock reference(ISCR) signal of the common PLP data to determine the ahead/behind relationship between the common PLP data and the non-common PLP data. Further, when the transport stream packet processed information S_TSP has been synthesized, the output module 108 may selectively output the common PLP data or the non-common PLP data according to the ahead/behind relationship obtained. If the control signal S_C is “1”, the output module outputs the common PLP data when the non-PLP data is null packets. It should be noted that, the reference clock circuit 304 of the embodiment further simultaneously performs detection to track whether the packet interval of the outputted output stream information S_TSO is correct while the output module 108 outputs the output stream information S_TSO.

In the above situation, again referring to FIG. 1 to FIG. 3, when the plurality of transport streams that the multimedia processing system 10 receives are compliant to the DVB-S2 standard, the multimedia processing system 10 sequentially operates the descrambler 102, the header processing circuit 200, the buffer processing circuit 202, the delay circuit 300, the reference clock circuit 304 and the output module 108 to perform respective operations. When the plurality of transport streams that the multimedia processing system 10 receives are compliant to the DVB-C2 standard, the multimedia processing system 10 sequentially operates the descrambler 102, the header processing circuit 200, the buffer processing circuit 202, the delay circuit 300, the buffer ratio circuit 302, the reference clock circuit 304 and the output module 108 to perform respective operations. Meanwhile, regardless of whether the plurality of transport streams that the multimedia processing system 10 receives are compliant to the DVB-S2 or DVB-C2 standard, the output module 108 of the embodiment is capable of correctly outputting the user-expected output stream information S_TSO, and detection is simultaneously performed by the reference clock circuit 304 to ensure the correctness of the output information.

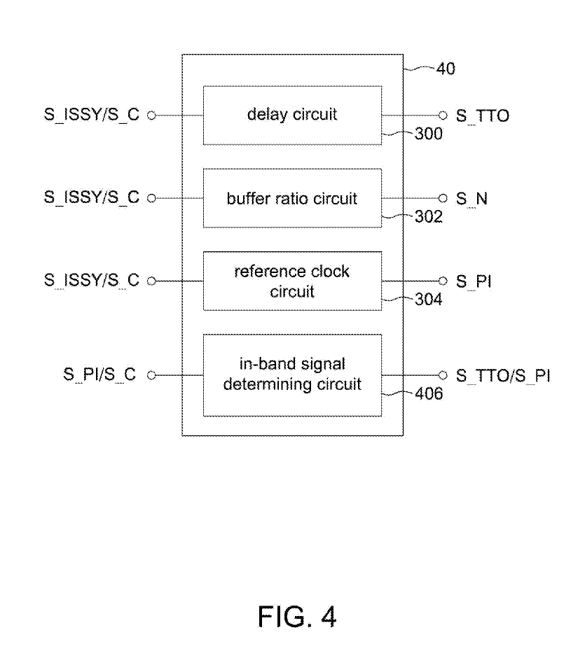

FIG. 4 shows a detailed block diagram of another timing control module 40 according to an embodiment of the present invention. Compared to the timing control module 30 in FIG. 3, in addition to the delay circuit 300, the buffer ratio circuit 302 and the reference clock circuit 304, the timing control module 40 in FIG. 4 further includes an in-band signal determining circuit 406. The in-band signal determining circuit 406 receives the control signal S_C and the padding information S_PI to generate the time-to-output signal S_TTO and the packet interval signal S_GI. Preferably, the in-band signal determining circuit 406 of the embodiment is prioritized to confirm whether an in-band signal of the padding information S_PI exists, e.g., confirming whether an in-band flag B field is a high-level signal, and then parses the in-band signal after the existence of the in-band signal is confirmed to obtain in-band type-B information and transmit the in-band type-B information to the output module 108.

Again referring to FIG. 1 to FIG. 4, when the plurality of transport streams that the multimedia processing system 10 receives are compliant to the DVB-T2 standard, the multimedia processing system 10 sequentially operates the descrambler 102, the header processing circuit 200, the buffer processing circuit 202, the in-band signal determining circuit 406, the delay circuit 300, the buffer ratio circuit 302, the reference clock circuit 304 and the output module 108 to perform respective operations, so as to allow the output module 108 to output the output stream information S_TSO. Meanwhile, the reference clock circuit 304 continues the detection to ensure that the output information is correct.

In practice, the descrambler 102 according to an embodiment of the present invention may be implemented by a DVB-T2 descrambler. Input signals of descramblers of the DVB-T2, DVB-C2 and DVT-S2 standards are roughly the same, with only differences of Kbch bit lengths of the transport stream S_TSI in these standards being different. Meanwhile, in a DVB-T2 system (e.g., S_C=2), the descrambler 102 further outputs S_PI for the use of the timing control module 106. In a DVB-C2 or DVB-S2 system, the timing control module 106 does not need the S_PI input signal. Thus, when S_C=0 or 1, the descrambler fills “0” at the S_PI output end instead of providing substantial and useful information to the timing control module 106. It is known from the above description that, the descrambler according to an embodiment of the present invention only needs to prepare a descrambler for the DVB-T2 standard instead of providing a descrambler for each of the DVB-T2, DVB-C2 and DVB-S2 standards, and a multi-standard output processor according to an embodiment of the present invention may then be made capable of processing signals of the DVB-T2, DVB-C2 and DVB-S2 standards.

The data processing module 104 according to an embodiment of the present invention may be implemented by a common data processing module used in the DVB-T2 or DVB-C2 standard. When S_C=1 or 2, the data processing module 104 determines whether the system is in an NM or HEM mode, and respectively provides the corresponding S_ISSY and S_TSP to the timing control module 106 and the output module 108. When S_C=0, because the DVB-S2 standard does not have an HEM mode, the data processing module 104 is not required to determine the mode, and circuits associated with the HEM mode may also be disabled. It is known from the above that, the descrambler according to an embodiment of the present invention only needs to prepare one data processing circuit for the DVB-T2 or DVB-C2 standard instead of providing a data processing module for each of the DVB-T2, DVB-C2 and DVB-S2 standards, and a multi-standard output processor according to an embodiment of the present invention may then be made capable of processing signals of the DVB-T2, DVB-C2 and DVB-S2 standards.

The timing control module 106 according to an embodiment of the present invention may be a combination of common timing control modules used in a DVB-T2 and DVB-C2 standard. When S_C=2, the timing control module of the DVB-C2 standard is disabled, and the timing control module 106 becomes equivalent to a common timing control module used in the DVB-T2 standard. When S_C=1, the timing control module of the DVB-T2 standard is disabled, and the timing control module 106 is equivalent to a common timing control module used in the DVB-C2 standard. When S_C=0, because the timing control module 106 is not required to process the multi-PLP in the DVB-C2 standard, in addition to the timing control module of the DVB-T2 standard that is disabled, circuits associated with the multi-PLP in the timing control module of the DVB-C2 standard are also disabled. At this point, the timing control module 106 is equivalent to a common timing control module used in the DVB-S2 standard. It is known from the above that, the descrambler according to an embodiment of the present invention only needs to prepare one data processing circuit for each of the DVB-T2 and DVB-C2 standards instead of having to prepare a timing control module for each of the DVB-T2, DVB-C2 and DVB-S2 standards, and a multi-standard output processor according to an embodiment of the present invention may then be made capable of processing signals of the DVB-T2, DVB-C2 and DVB-S2 standards.

The output module 108 according to an embodiment of the present invention may be a combination of common output modules used in the DVB-T2 or DVB-C2 standard. When S_C=2, the output module of the DVB-C2 standard is disabled, and the output module 108 is equivalent to a common output module used in the DVB-T2 standard. When S_C=1, the output module of the DVB-T2 standard is disabled, and the output module 108 is equivalent to a common output module used in the DVB-C2 standard. When S_C=0, because the output module 108 is not required to process multi-PLP in the DVB-C2 standard, in addition to the output module of the DVB-T2 that is disabled, circuits associated with the multi-PLP in the output module used in the DVB-C2 standard are also disabled. At this point, the output module 108 is equivalent to a common output module used in the DVB-S2 standard. It is known from the above that, the descrambler according to an embodiment of the present invention only needs to prepare one output module for each of the DVB-T2 and DVB-C2 standards instead of having to prepare a timing control module for each of the DVB-T2, DVB-C2 and DVB-S2 standards, and a multi-standard output processor according to an embodiment of the present invention may then be made capable of processing signals of the DVB-T2, DVB-C2 and DVB-S2 standards.

Various implementation examples of a multi-standard output processor according to an embodiment of the present invention are described as above. It should be noted that, the scope of the present invention is not limited to the above implementation examples. More specifically, if (sub-)timing control modules of the DVB-T2 and DVB-C2 standards in the timing control module 106 have shared circuits, the timing control module 106 is not required to provide respective complete timing control modules for the DVB-T2 and DVB-C2 standards. Similarly, if (sub-)output modules of the DVB-T2 and DVB-C2 standards in the output module 108 have shared circuits, the output module 108 is not required to provide respective complete output modules for the DVB-T2 and DVB-C2 standards.

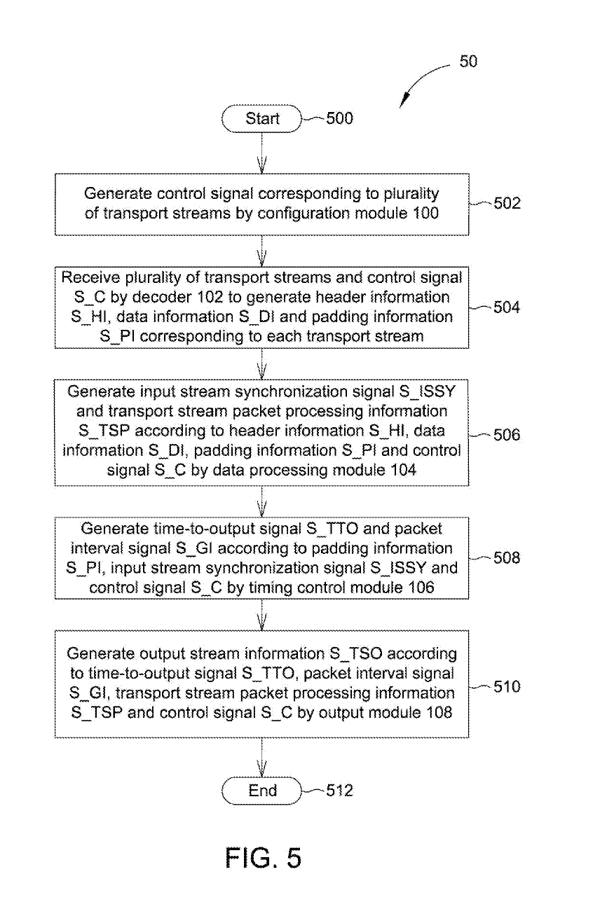

Further, in the embodiment, a control method may be used to correspondingly perform associated operations of a plurality of transport streams corresponding to multiple video broadcasting standards that the multimedia processing system 10 receives. The control method of the embodiment may be concluded into a control process 50, which is coded as a program code, stored in a storage device of the multimedia processing system 10 and performed by a processor module of the multimedia processing system 10. As shown in FIG. 5, the control process 50 includes following steps.

In step 500, the control process 50 begins.

In step 502, the configuration module 100 generates the control signal S_C corresponding to the plurality of transport streams.

In step 504, the descrambler 102 receives the plurality of transport streams and the control signal S_C to generate the header information S_HI, the data information S_DI and the padding information S_PI corresponding to each of the transport streams.

In step 506, the data processing module 104 generates the input stream synchronization signal S_ISSY and the transport stream packet processed information S_TSP according to the header information S_HI, the data information S_DI, the padding information S_PI and the control signal S_C.

In step 508, the timing control module 106 generates the time-to-output signal S_TTO and the packet interval signal S_GI according to the padding information S_PI, the input stream synchronization signal S_ISSY and the control signal S_C.

In step 510, the output module 108 generates the output stream information S_TSO according to the time-to-output signal S_TTO, the packet interval signal S_GI, the transport stream packet processed information S_TSP and the control signal S_C.

In step 512, the control process 50 ends.

Operations details of the control process 50 according to the embodiment of the present invention may be referred from the description associated with the embodiments in FIG. 1 to FIG. 4, and shall be omitted herein. Preferably, the program code corresponding to the control process 50 may be divided into a plurality of sub-codes, which are respectively stored in the configuration module 100, the descrambler 102, the data processing module 104 (including the header processing circuit 200 and the buffer processing circuit 202), the timing control module 106 (including the delay circuit 300, the buffer rate circuit 302, the reference clock circuit 304 and/or the in-band signal determining circuit 406), and the output module 108, so as to enhance the processing performance of the multimedia processing system 10. However, the above examples are not to be construed as limitations to the present invention.

In conclusion, the embodiments of the present invention teach a multimedia processing system and control method capable of processing a plurality of transport streams corresponding to the DVB-S2, DVB-C2 and DVB-S2 standards. Therefore, with only one set of hardware equipment, a user may complete the coding of the plurality of transport streams of multiple video broadcasting standards, thereby not only expanding the application scope of the multimedia processing system but also enhancing application convenience for users.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia processing system, for processing a plurality of transport streams of a plurality of video broadcasting standards, the multimedia processing system comprising:
a configuration module, generating a control signal corresponding to the plurality of transport streams to configure an operation mode, the operation mode corresponding to one of the digital video broadcasting standards;
a descrambler, coupled to the configuration module, receiving one of the plurality of transport streams and the control signal to generate header information, data information and padding information;
a data processing module, coupled to the descrambler and the configuration module, receiving the control signal, the header information, the data information and the control signal to generate an input stream synchronization signal and transport stream packet processed information;
a timing control module, coupled to the data processing module and the configuration module, receiving the padding information, the input stream synchronization signal and the control signal to generate a time-to-output signal and a packet interval signal; and
an output module, coupled to the data processing module, the timing control module and the configuration module, receiving the time-to-output signal, the packet interval signal, the transport stream packet processed information and the control signal to generate output stream information.

2. The multimedia processing system according to claim 1, wherein the data processing circuit comprises:
a header processing circuit, receiving the header information to generate header processed information; and
a buffer processing circuit, receiving the header processed information, the control signal and the data information to generate the input stream synchronization signal and the transport stream packet processed information.

3. The multimedia processing system according to claim 1, wherein the timing control module comprises:
a delay circuit, receiving the input stream synchronization signal and the control signal to generate the time-to-output signal;
a buffer ratio circuit, receiving the input stream synchronization signal and the control signal to generate a buffer data number signal; and
a reference clock circuit, receiving the input stream synchronization signal and the control signal to generate the packet interval signal.

4. The multimedia processing system according to claim 3, wherein when the plurality of transport streams are applicable to the Digital Video Broadcasting-Satellite Generation Two (DVB-S2) standard, the delay circuit and the reference clock circuit operate and output the time-to-output signal and the packet interval signal to the output module.

5. The multimedia processing system according to claim 3, wherein when the plurality of transport streams are applicable to the Digital Video Broadcasting-Cable Generation Two (DVB-C2) standard, the delay circuit, the buffer ratio circuit and the reference clock circuit operate and output the time-to-output signal and the packet interval signal to the output module.

6. The multimedia processing system according to claim 3, wherein the timing control module further comprises an in-band signal determining circuit, which receives the control signal and the padding information to generate the time-to-output signal and the packet interval signal.

7. The multimedia processing system according to claim 6, wherein when the plurality of transport streams are applicable to the Digital Video Broadcasting-Terrestrial Generation Two (DVB-T2) standard, the in-band signal determining circuit, the delay circuit, the buffer ratio circuit and the reference clock circuit operate and output the time-to-output signal and the packet interval signal to the output module.

8. The multimedia processing system according to claim 1, wherein the output module further performs null packet insertion to output the output stream information.

9. A control method, for processing a plurality of transport streams of a plurality of video broadcasting standards applicable to a multimedia processing system, the multimedia processing system comprising a configuration module, a descrambler, a data processing module, a timing control module and an output module, the control method comprising:
generating a control signal corresponding to the plurality of transport streams by the configuration module;
receiving one of the plurality of transport streams and the control signal to generate header information, data information and padding information by the descrambler;
generating an input stream synchronization signal and transport stream packet processed information according to the header information, the data information and the control signal by the data processing module;
generating a time-to-output signal and the packet interval signal according to the padding information, the input stream synchronization signal and the control signal be the timing control module; and
generating output stream information according to the time-to-output signal, the packet interval signal, the transport stream packet processed information and the control signal by the output module.

10. The control method according to claim 9, wherein the data processing circuit comprises a header processing circuit and the buffer processing circuit, the header information is received by the header processing circuit to generate header processed information, and the header processed information, the control signal and the data information are received by the buffer processing circuit to generate the input stream synchronization signal and the transport stream packet processed information.

11. The control method according to claim 9, wherein the timing control module comprises a delay circuit and a reference clock circuit, the input stream synchronization signal and the control signal are received to generate the time-to-output signal by the delay circuit, the input stream synchronization signal and the control signal are received to generate a buffer data number signal by the buffer ratio circuit, and the input stream synchronization signal and the control signal are received to generate the packet interval signal by the reference clock circuit.

12. The control method according to claim 11, wherein when the plurality of transport streams are applicable to the Digital Video Broadcasting-Satellite Generation Two (DVB-S2) standard, the delay circuit and the reference clock circuit operate and output the time-to-output signal and the packet interval signal to the output module.

13. The control method according to claim 11, wherein when the plurality of transport streams are applicable to the Digital Video Broadcasting-Cable Generation Two (DVB-C2) standard, the delay circuit, the buffer ratio circuit and the reference clock circuit operate and output the time-to-output signal and the packet interval signal to the output module.

14. The control method according to claim 11, wherein the timing control module further comprises an in-band signal determining circuit, which receives the control signal and the padding information to generate the time-to-output signal and the packet interval signal.

15. The control method according to claim 14, wherein when the plurality of transport streams are applicable to the Digital Video Broadcasting-Terrestrial Generation Two (DVB-T2) standard, the in-band signal determining circuit, the delay circuit, the buffer ratio circuit and the reference clock circuit operate and output the time-to-output signal and the packet interval signal to the output module.

16. The control method according to claim 9, wherein the output module further performs null packet insertion to output the output stream information.
